(19) United States
(12) Patent Application Publication
(10) Pub. No.: US 2015/0043578 A1
(43) Pub. Date: Feb. 12, 2015

(54) Home Network Packet Delivery

(71) Applicants: Mark W Fidler, Granite Bay, CA (US); Kenneth Lloyd Taggard, Roseville, CA (US); Luis Astudillo Pascual, JR., Roseville, CA (US)

(72) Inventors: Mark W Fidler, Granite Bay, CA (US); Kenneth Lloyd Taggard, Roseville, CA (US); Luis Astudillo Pascual, JR., Roseville, CA (US)

(21) Appl. No.: 14/377,928

(22) PCT Filed: Apr. 27, 2012
(86) PCT No.: PCT/US2012/035567

§ 371 Date: Aug. 11, 2014

(51) Int. Cl. H04L 12/18; H04L 12/741; H04L 12/721

(52) U.S. Cl. CPC H04L 12/18; H04L 45/66; H04L 45/74; H04L 45/32
USPC 370/390

(57) ABSTRACT

An example system includes a handler device and an edge device. The handler device is configured to receive a first packet, generate a second packet by encapsulating the first packet in a tunnel format, and forward the second packet, wherein the destination address of the second packet is a multicast address assigned to a home network associated with the handler device. The edge device configured to receive the second packet, decapsulate the second packet to obtain the first packet, and forward the first packet to one or more clients associated with the home network.

### BACKGROUND

In the networking technology space, the concept of a “home network” for roamed/mobile clients has been introduced. The home network is a point of presence on the network, where each client in the network is assigned to a particular home network. The goal of the home network approach is to make associated clients appear as wired clients on the home network regardless of where the clients may be connected on the network. For example, even if a client is attached to a remote network via a remote edge device, the client appears as a wired device connected to the home network. This local connectivity illusion is generally accomplished by utilizing a tunnel or series of tunnels between infrastructure devices to transport packets to and from clients and a handier device for the home network. Stated differently, a handler device for the home network generates a unique tunnel to each edge device (which may or may not contain a client from the home network), and the handler device transmits received packets via the unique tunnels to the clients.

### BRIEF DESCRIPTION OF THE DRAWINGS

Example embodiments are described in the following detailed description and in reference to the drawings, in which:

FIG. 1 depicts a block diagram of a system in accordance with an embodiment.

FIG. 2 depicts a graphical representation of a system in accordance with an embodiment;

FIG. 3 depicts a process flow diagram describing setup operations in accordance with an embodiment;

FIG. 4 depicts a process flow diagram for receiving and encapsulating a flooded packet in accordance with en embodiment;

FIG. 5 depicts a process flow diagram for receiving and decapsulating an encapsulated packet in accordance with an embodiment; and

FIG. 6 depicts a handier device and/or edge device in accordance with an embodiment.

### DETAILED DESCRIPTION

Various embodiments described herein are directed to the improved communication of flooded packets (e.g., broadcast packets, multicast packets, and unknown destination address (DA) packets) in a “home network” environment. More particularly, various embodiments are directed to a novel and previously unforeseen approach to improve flooded packet communication by utilizing multicasting techniques to deliver flooded packets in a home network environment.

In current systems utilizing the “home network” approach, a tunnel or a series of tunnels is used to transmit packets to/fro m the home network and a client, While this approach works well for packets coming from clients and for unicast packets delivered from the home network, when applied to flooded packets (e.g., layer 2 flooded packets such as broadcast packets, multicast packets, and unknown DA packets), the result is not the same because the network device responsible for sourcing the packets (e.g., the handier device) must replicate the flooded packet into all of the tunnels going to the edge devices. In some instances, this may involve replicating the flooded packet hundreds or even thousands of times. This is problematic because, among other things, it places a significant load on the network device responsible for sourcing the packets into the tunnels, and because it leads to inefficient use of network resources.

Various embodiments described herein address at least the above by multicasting techniques to deliver flooded packets in accordance with the home network approach. In general, and by way of example, each home network is assigned a multicast address and a handler device. When the handler device for the home network receives a flooded packet, the handler device encapsulates the flooded packet with a destination address set to the multicast address assigned to the home network. The handler device then forwards the encapsulated packet using various multicast forwarding rules. When an edge device that has joined the multicast group for the home network receives the encapsulated packet, it decapsulates the packet and forwards the internal flooded packet to the particular clients associated with the home network.

By utilizing above-mentioned approach, the load on the handler device may be reduced when compared to current approaches because the handier device does not have to replicate flooded packets to each tunnel. Moreover, multicast joins/prunes may be used to update where the flooded packets are distributed, rather than having to track such distribution information in a forwarding table at the handler device. These benefits as well as other benefits are discussed in greater detail below with reference to various embodiments and various illustrative figures.

In one example embodiment, a system is provided. The system comprises a handler device and an edge device, The handler device is configured to receive a first packet (e.g., a layer 2 flooded packet such as a broadcast packet. multicast packet, or unknown DA packets) and generate a second packet by encapsulating the first packet in a tunnel format, wherein the destination address of the second packet is a multicast address assigned to a horns network associated with the handler device. The handler device then forwards the second packet to the edge device. The edge device is configured to receive the second packet, decapsulate the second packet to obtain the first packet, and forward the first packet to one or more clients associated with the home network.

In another example, a handier device is provided. The handler device comprises a processing device and a memory. The memory comprises instructions that when executed by the processing device, cause the handler device to (i) receive a first packet: (ii) generate a second packet by encapsulating the first packet in a tunnel format, wherein the second packet's destination address is a multicast address assigned to the handler device's home network; and (iii) forward the second packet.

In still another example embodiment, an edge device is provided. The edge device comprises a processing device and a memory. The memory comprises instructions that when executed by the processing device, cause the edge device to receive a packet, wherein the packet is an encapsulated packet comprising a layer 2 flooded packet, and wherein the destination address of the packet is a multicast address assigned to a home network; (ii) decapsulate the packet to obtain the layer 2 flooded packet; and (iii) forward the layer 2 flooded packet to one or more clients associated with the home network.

In yet another example embodiment, a hander device is provided. The handler device comprises a communication interface and a circuit (e.g., an application specific integrated circuit (ASIC)). The communication interface is configured to receive a first packet. The circuit is configured to generate a second packet by encapsulating the first packet in a tunnel format, wherein the destination address of the second packet is a multicast address assigned to a home network associated with the handler device.

In a further example embodiment, an edge device is provided. The edge device comprises a communication interface and a circuit (e.g., an ASIC). The communication interface is configured to receive a second packet, wherein the second packet is an encapsulated packet comprising a first packet, and wherein the destination address of the second packet is a multicast address assigned to a home network. The circuit is configured to decapsulate the second packet to obtain the first packet, and to forward the first packet to one or more clients associated with the home network.

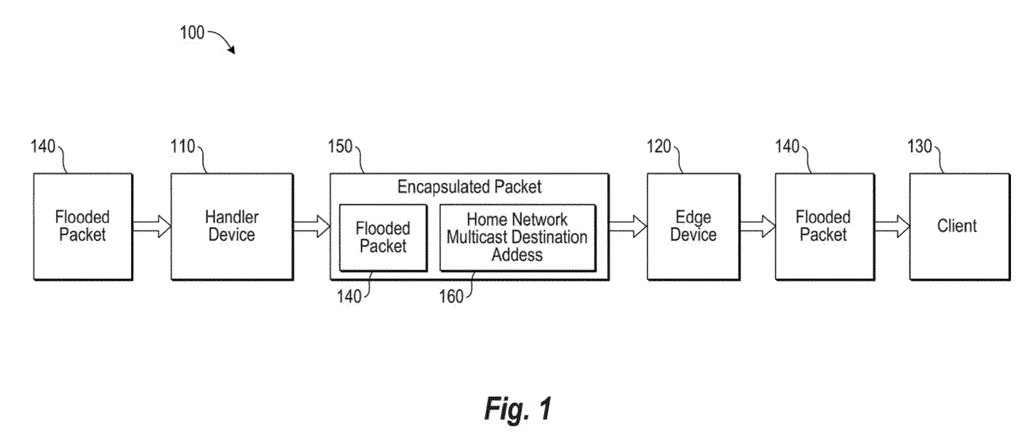

FIG. 1 depicts a block diagram of a system 100 in accordance with an embodiment. It should be readily apparent that the system 100 depicted in FIG. 1 represents a generalized illustration and that other components may be added or existing components may be removed, modified, or rearranged without departing from a scope of the present disclosure.

The system 100 comprises a handier device 110, an edge device 120, and a client 130. The handier device 110 is a network infrastructure device such as a switch, controller, router, and/or PC that is configured to be rendezvous point or demarcation point for a particular home network. The handler device may be responsible for receiving flooded packets for the home network, encapsulating the flooded packets with a destination address set to the multicast address for the home network, and forwarding the encapsulated packets using multicast forwarding rules. Each home network may have one handler device 110, and an administrator or controller may assign a particular handler device 110 to each home network. In some implementations, the handler device 110 for one home network may be the edge device 120 for another home network.

The edge device 120 is a network infrastructure device that requires access to the home network. For example, the edge device 120 may be an access, point, switch, router, and/or computer. The edge device 120 may be configured to ascertain the home network and multicast group for each of its attached clients, and on the respective multicast group. In response to receiving an encapsulated packet from the handler device, the edge device 120 may be configured to decapsulate the packet and forward the internal flooded packet to the clients associated with the particular home network. The edge device 120 may utilize wireless and/or wired mediums (e.g.,, radio frequency (RF), fiber-optic, coaxial, twisted pair, etc.) to communicate with clients and/or other network infrastructure devices. Furthermore, the edge device 120 may utilize various communication/authentications protocols to communicate with clients and/or other network infrastructure devices (e.g., 802.11x, TCP/IP 802.1x, etc).

The client 130 is a user device that connects to the edge device 120. For example, the client 130 may be a laptop, desktop, workstation, tablet, smart phone, medical instrument, and/or scientific instrument.

The handler device 110, edge device 120, and/or client 130 may comprise a plurality of components to enable operation. For example, the handler device 110, edge device 120, and/or client 130 may comprise one or more processing devices (e.g., central processing units, processors, micro-controllers, etc.), memories (e.g., non-volatile memory, volatile memory, storage devices, etc.), communication interfaces (e.g., receivers, transmitters, transceivers, PHYs, ports, antennas. etc.), and/or circuits (e.g., ICs, ASICs, CPLDs, PALs, FPGAs etc.)). In some implementations, a processing device executes instructions stored on memory to enable handler device 110, edge device 120, and/or client 130 operations discussed herein. In other implementations, functionally equivalent circuits like an ASIC enable handler device 110, edge device 120, and/or client 130 operations discussed herein.

Turning now to system 100 operations, in various embodiments, the handler device 110 is configured to receive flooded packets 140 for the home network. A flooded packet may be, for example, a layer 2 flooded packet such as a broadcast packet, multicast packet, or unknown DA packets. Upon receiving such a flooded packet 140, the handler device 110 may conduct filtering operations (e.g., the handler device may filter which downstream devices are to receive the flooded packets based on, e.g., traffic monitoring patterns). The handler device 110 may then encapsulate the flooded packet 140 into a tunnel format (e.g., generic route encapsulation (GRE)), wherein the destination address is the multicast address for that particular home network. Stated differently, the handler device 110 may produce an encapsulated packet 150 which comprises the flooded packet 140 and a destination address 160 set to the home network multicast address. The handler device 110 may then forward the encapsulated packet 150 using multicast forwarding rules.

The edge device 120 is configured to receive the encapsulated packet 150 forwarded by the handier device 10. The edge device 120 then determines if it has clients associated with the multicast address and/or home network. If so, the edge device decapsulates the encapsulated packet 150 to obtain the flooded packet 140. The edge device 120 may then forward the flooded packet 140 to each attached client 130 associated with the home network. Such a process may occur at each edge device 120 that receives the encapsulated packet 150. Furthermore, such a process may include filtering operations to pare-down the amount of recipients of decapsulated flooded packets.

By virtue of the above-mentioned process, each client 120 associated with the home network will receive the flooded packet in a manner that is less burdensome on network resources, and requires less replication of the flooded packet by the handler device.

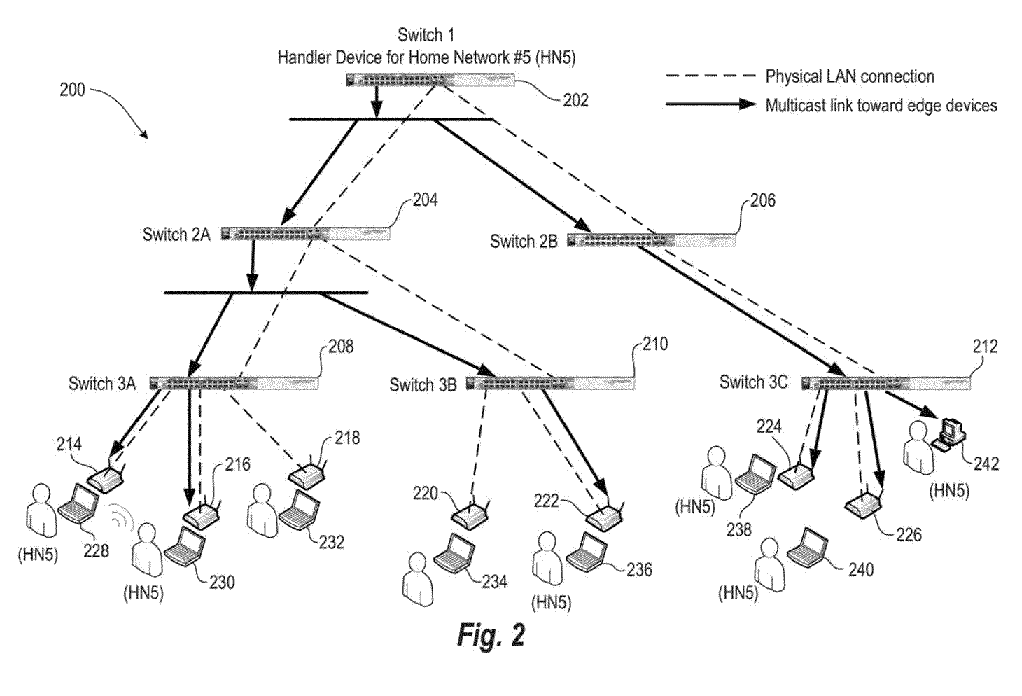

FIG. 2 depicts a graphical representation of a system in accordance with an embodiment. The system includes a handler device 202, a plurality of switches 204-212, a plurality of access points 214-226, and a plurality of clients 228-242. The access points 214-226 may serve as edge devices for mobile clients 228-240, and switch 212 may serve as an edge device or edge switch for wired client 242.

In the example shown, the handler device 202 is the assigned handler device for “home network #5,” and clients 228, 230, 236, 238, 240. and 242 are all associated with home network #5. The paths shown in dotted lines are physical LAN connections between the network devices, and the paths shown in solid lines with arrows are multicast links toward edge devices,

As is apparent from FIG. 2, multicast links are only established to edge devices that have at least one client that is associated with home network #5 (e.g., edge devices 212, 214, 216, 222, 224, and 226). As discussed further below, these edge devices are configured to join the multicast group associated with home network #5 when the client attaches to the edge device. By contrast, multicast links are not established to edge devices that do not have clients associated with home network #5 (e.g., edge devices 218 and 220). Of course, if these edge devices have clients associated with other home networks (e.g., home network #2, home network #7, etc.), multicast links will be established to receive flooded packets for those home networks via multicast group join messaging.

The handler device 202 may be configured to receive all flooded packets for home network #5. The handler device 202 may encapsulate the flooded packets with a destination address set to the multicast address for home network #5. Thereafter, the handler device 202 may forward the encapsulated packets based on various multicasting forwarding techniques. For example, the handler device 202 may forward the encapsulated packets in accordance with RFC 5015 (“Bidirectional Protocol independent Multicast”). The encapsulated packets are forwarded to all network devices that have joined the multicast group for home network #5. Such devices may join the multicast group because they have attached clients that are associated with home network #5 and/or because their downstream devices (e.g., switches/access points) have attached clients that are associated with home network #5. In FIG. 2, therefore, edge device 214 will join the multicast group for home network #5 because client 228 is associated with home network #5. Edge devices 212, 216, 222, 224, and 226 will similarly join the multicast group for home network #5 because clients 230, 236, 238, 240, and 242 are associated with home network #5.

Because the above-mentioned edge devices are connected to the handler device 202 via various intermediate switches (i.e., switches 204, 206, 208, 210, and 212), these switches will also join the multicast group for home network #5 in order to deliver the packets downstream to the clients that are associated with home network #5. In instances where a switch does not have an attached client that is associated with home network #5, the switch will not decapsulate the received encapsulated packet, but rather forward the encapsulated packet to downstream devices that have joined the multicast group. For example, switch 204 may receive an encapsulated packet from the handler device 202. Based on the multicast address associated with the encapsulated packet, switch 204 may determine that it does not have an attached client that is associated with the multicast group for home network #5, but that it does have downstream devices (switch 208 and 210) that have joined the multicast group. Thus, switch 204 will forward the encapsulated packet to switches 208 and 210.

By contrast if switch 204 determined that it did have an attached client that is associated with the multicast group for home network #5, switch 204 would decapsulate the packet and deliver the flooded packet to the attached client that is associated with the multicast group for home network #5. In addition, switch 204 may forward the encapsulated packet to switches 208 and 210 because these downstream devices have joined the multicast group. Similar processes and determinations may occur at switches 206, 208, 210, and 212. For example, switch 212 may determine that it has an attached client 242 that is associated with the multicast group for home network #5. Switch 212 may then decapsulate the packet and deliver the internal flooded packet to the attached client 242 that is associated with the multicast group for home network #5, In addition, switch 212 may forward the encapsulated packet to downstream devices 224 and 226 because these downstream devices have joined the multicast group.

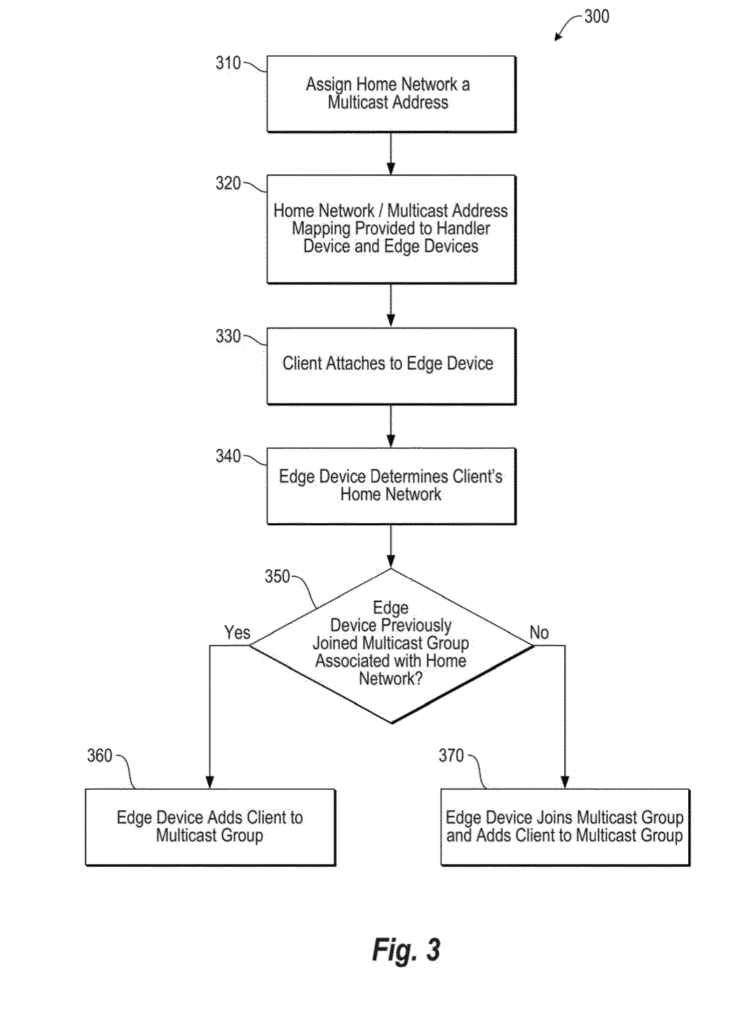

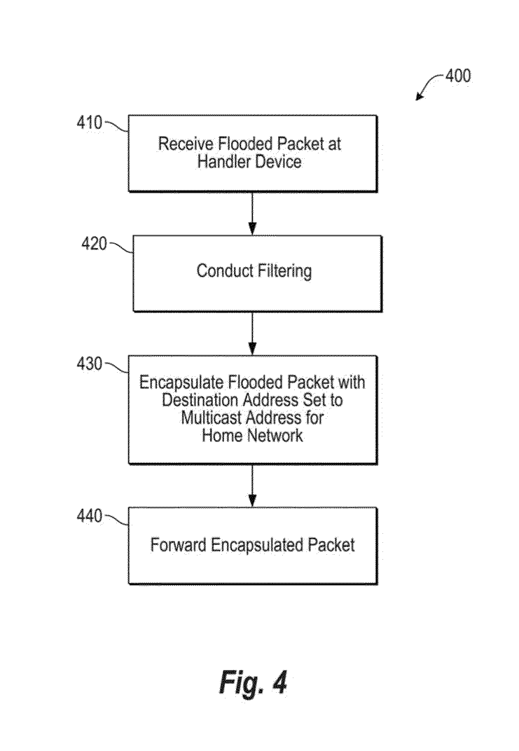

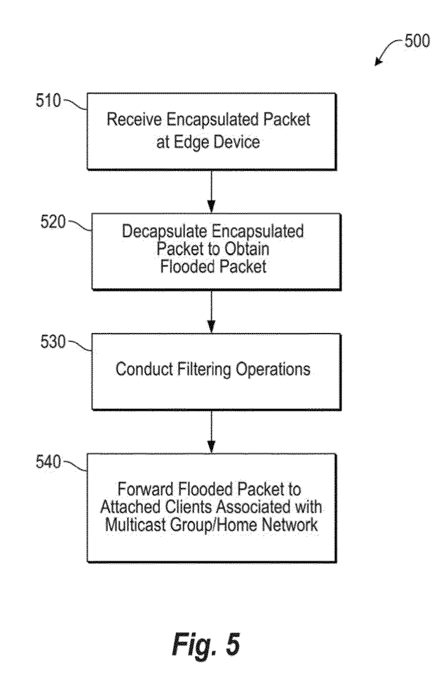

FIG. 3 generally depicts a process flow diagram 300 for setting up a network to conduct operations in accordance with an embodiment. It should be readily apparent that the processes depicted in FIG. 3 (as well as FIGS. 4 and 5) represent generalized illustrations, and that other processes may be added or existing processes may be removed, modified, or rearranged without departing from the scope and spirit of the present disclosure. Further, it should be understood that the processes may represent executable instructions stored on memory that may cause a processing device to respond, to perform actions, to change states, and/or to make decisions. Thus, the described processes may be implemented as executable instructions and/or operations provided by a memory associated with a handier device 113, edge device 120, and/or client 130, Moreover, the processes may represent functions and/or actions performed by functionally equivalent circuits like an ASIC associated with a handler device 110, edge device 120, and/or client 130. Furthermore, FIG. 3 (as well as FIGS. 4 and 5) is not intended to limit the implementation of the described embodiments, but rather the figure illustrates functional information one skilled in the art could use to design/fabricate circuits, generate software, or use a combination of hardware and software to perform the illustrated processes.

The process 300 may begin at block 310 where a multicast address is assigned to the home network. This process may be conducted manually by an administrator or via an automated process. In particular, an administrator or automated process may assign the home network a multicast address from one of the unused multicast addresses on the network. Once a multicast address is assigned to the home network, at block 320, the mapping between the multicast address and home network may be provided to the handler device and the edge devices. The handler device and each edge device will therefore be aware of the multicast address assigned to the particular home network. As a result, the handler device will know which multicast address to utilize for flooded packets received for the home network. Similarly, the edge devices will know which home network a received packet with a multicast address originates from.

At block 330, a client attaches to an edge device. This may involve, for example, a client attaching to a wireless access point or a client connecting to a port of a switch. At block 340, the edge device determines the client's home network. This may be determined via information that is stored, information provided by the client, information provided by a controller, and/or information provided by another network device (e.g., a Radius server). In one example, the client's home network information may be shared by neighboring edge devices. Based on the client's home network information, the edge device determines the multicast group assigned to the home network. This may similarly be accomplished via information that is stored, information provided by the client, information provided by a controller, and/or information provided by another network device. At block 350, the edge device then determines whether or not it has already joined the multicast group for the home network. If the edge device has already joined the multicast group for the home network, at block 360, the edge device adds the client to the multicast group such that, when the edge device receives a packet for the particular multicast group, the edge device knows to forward the packet to the client. If the edge device has not already joined the multicast group for the home network, at block 370, the edge device joins the multicast group. This may be accomplished by the edge device transmitting a multicast join message that ripples through the network until it reaches a device that has already joined the multicast group, or until it reaches the handier device for the home network. In addition, the edge device adds the client to the multicast group such that, when the edge device receives a packet for the multicast group, the edge device knows to forward the packet to the client.

FIG. 4 generally depicts a process flow diagram 400 for receiving and encapsulating a flooded packet in accordance with an embodiment. The process may begin at block 410, where the handler device receives a flooded packet such as a broadcast packet, multicast packet, or an unknown destination address packet. At block 420, the handler device conducts filtering operations. This filtering may include, for example, the handler device filtering which devices are to receive the flooded packets based on, e.g., traffic monitoring patterns. At block 430, the handler device encapsulates the flooded packet using a tunnel format such as GRE, and sets the destination address for the encapsulated packet to the multicast address for the home network. The handler device then, at block 440, forwards the encapsulated packet using multicast forwarding rules.

FIG. 5 generally depicts a process flow diagram 500 for receiving and decapsulating an encapsulated packet in accordance with an embodiment. The process may begin at block 510, where an edge device (e.g., a switch or access point) receives an encapsulated packet comprising a flooded packet and addressed to multicast address of a home network. At block 520, the edge device decapsulates the encapsulated packet to obtain the flooded packet. Then, at block 530, the edge device conducts filtering operations to pare-down the recipient list such that only particular clients receive the flooded message. Thereafter, at block 540, the edge device forwards the flooded packet to the edge device's attached client(s) that are associated with the multicast group and home network, and/or in accordance with the result of the filtering operation.

As mentioned above, each edge device may maintain a mapping between various clients, home networks, and/or multicast addresses, Thus, when the edge device receives an encapsulated packet with an associated multicast address, the edge device can determine which of its attached clients are to receive flooded packet within the encapsulated packet. This process may or may not include filtering operations where the edge device conducts filtering according to filtering settings so that only particular clients receive the flooded message.

The edge device may further be configured to update stored mappings based on client behavior. For example, if a client disconnects from an edge device, the edge device may be configured to update its mapping table to remove the client from the multicast group. In the event that every client associated with a multicast group disconnects, the edge device may be configured to disconnect from the multicast group. Thus, the edge device should not receive encapsulated/flooded packets for the particular multicast group because it no longer has clients associated with the home network.

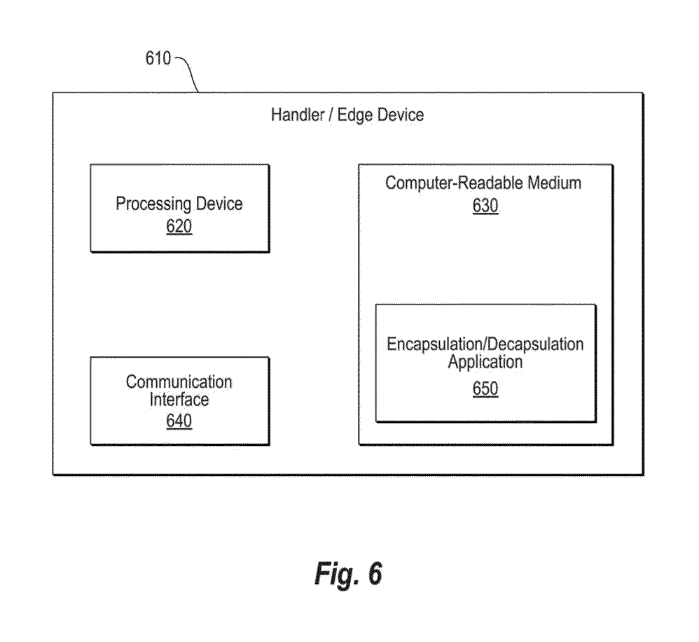

FIG. 6 depicts a handler device and/or edge device 10 in accordance with an embodiment. It should be readily apparent that the figure represents a generalized illustration and that other components may be added or existing components may be removed, modified, or rearranged without departing from a scope of the present disclosure. The handler device and/or edge device 610 comprises a processing device 620, a computer readable medium 630, and a communication interface 640, each of which is described in greater detail below.

The processing device 610 is configured to retrieve and execute instructions stored in the computer readable medium 630. The processing device 610 may be, for example, a processor, a central processing unit (CPU), a microcontroller, processor, or the like. The computer readable medium 630 may be a non-transitory computer-readable medium configured to store machine readable instructions, codes, data, and/or other information (e.g., an encapsulation/decapsulation application 650 in accordance with the above-described embodiments). The computer readable medium 630 may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. In certain embodiments, the computer readable medium 630 may be integrated with the processing device 620, while in other embodiments, the computer readable medium 630 may be discrete from the processing device 620.

The communication interface 640 is configured to transmit and receive data. Such data may comprise at least the types of data described throughout this disclosure. The communication interface 640 may comprise one or more components such as, for example, transmitters, receivers, transceivers, antennas, ports, and/or PHYs. It should be understood that the communication interface 640 may comprise multiple interfaces, and that each may serve a different purpose (e.g., to interface with the client, to interface with the handler device, etc.).

The processing device 620 may be configured to execute cod stored on the computer readable medium 630 to enable the handler device and/or edge device to conduct operations discussed herein. For example, in the case of a handler device, the processor 620 may execute an encapsulation application 650 to perform operations discussed above on flooded packets received via the communication interface 640. In the case of an edge device, the processor 620 may execute a decapsulation application 650 to perform operations discussed above on encapsulated packets received via the communication interface 640 indirectly or directly from a handler device.

In alternate embodiments, the handler device and/or edge device may utilize a functionally equivalent circuit to conduct the above mentioned functions, For example, the handler device may include a communication interface and a circuit (e.g., an application specific integrated circuit (ASIC)). The communication interface may be configured to receive a first packet (e.g., a layer 2 flooded packet), and the circuit may be configured to generate a second packet by encapsulating the first packet in a tunnel format, wherein the destination address of the second packet is a multicast address assigned to a home network associated with the handler device. Similarly, an edge device may include a communication interface and a circuit (e.g., rare ASIC). The communication interface may be configured to receive a second packet, wherein the second packet is an encapsulated packet comprising a first packet, and wherein the destination address of the second packet is a multicast address assigned to a home network. The circuit may be configured to decapsulate the second packet to obtain the first packet, and to forward the first packet to one or more clients associated with the home network.

The foregoing describes a novel and previously unforeseen approach to distribute flooded packets from home networks to roamed/mobile clients. In particular, various embodiments utilize tunnels with multicast addresses to send flooded packets (e.g., broadcast packets) to clients. Multicast replication methods may be used to distribute the data in a tree-like fashion, which effectively reduces overall traffic on the network and the handier device which resides on the home network. Each home network may be assigned a unique multicast address and the infrastructure devices may use multicast technology to join the multicast group based on the clients attached. The edge device which has the client attached may join the multicast group related to a home network when a client for that network is connected to that particular edge device. The join may be passed within the network until it reaches an infrastructure device which already has joined that particular multicast group. If the edge device already participates in that multicast group, then the edge device may simply add that device to a group table which resides on that device.

The present disclosure has been shown and described with reference to the foregoing exemplary embodiments. It is to be understood, however, that other forms, details, and embodiments may be made without departing from the spirit and scope of the disclosure that is defined in the following claims.

What is claimed is:

1. A system comprising:
a handler device to
receive a first packet,
generate a second packet by encapsulating the first packet in a tunnel format, wherein the destination address of the second packet is a multicast address assigned to a home network associated with the handler device, and
forward the second packet; and
an edge device to
receive the second packet,
decapsulate the second packet to obtain the first packet;
forward the first packet to one or more clients associated with the home network.

2. The system of claim 1, wherein the first packet is a layer 2 flooded packet.

3. The system of where in the first packet is a broadcast packet.

4. The system of claim 1, wherein the edge device is further to join a multicast group associated with the home network.

5. The system of claim 1, wherein the handler device is to process layer 2 flooded packets for the home network.

6. The system of claim 1, wherein the edge device part of a remote network.

7. The system of claim 1, wherein the edge device is further to determine a home network associated with each attached client, and join the multicast group mapped to each home network.

8. The system of claim 1, wherein the edge device is to store a mapping between home networks and multicast addresses.

9. A hander device comprising:
a processing device; and
a memory, wherein the memory comprises instructions that when executed by the processing device, cause the handler device to
receive a first packet;
generate a second packet by encapsulating the first packet in a tunnel format, wherein the second packet's destination address is a multicast address assigned to the handler device's home network; and
forward the second packet.

10. The handler device of claim 9, wherein the first pocket is a layer 2 flooded packet.

11. The handier device of claim 9, wherein the handler device is responsible for processing all flooded packets form home network.

12. The handler device of claim 9, wherein the first packet is a broadcast packet.

13. An edge device comprising:
a processing device; and
a memory, wherein the memory comprises instructions that when executed by the processing device, cause the edge device to
receive a packet, wherein the packet is an encapsulated packet comprising a layer 2 flooded packet, and wherein the destination address of the packet is a multicast address assigned to a home network;
decapsulate the packet to obtain the layer 2 flooded packet; and
forward the layer 2 flooded packet to one or more clients associated with the home network.

14. The edge device of claim 13, wherein the memory comprises further instructions that when executed by the processing device cause the edge device to join a multicast group associated with the home network.

15. The edge device of claim 13, wherein the memory comprises further instructions that when executed by the processing device cause the edge device to determine one or more home networks associated with the one or more clients.

16. A handler device, comprising:
a communication interface to receive a first packet; and
a circuit to generate a second packet by encapsulating the first packet in a tunnel format, wherein the destination address of the second packet is a multicast address assigned to a home network associated with the handler device.

17. The handler device of claim 16, wherein the first packet is a layer 2 flooded packet.

18. An edge device, comprising:
a communication interface to receive a second packet, wherein the second packet is an encapsulated packet comprising a first packet, and wherein the destination address of the second packet is a multicast address assigned to a home network; and
a circuit to decapsulate the second packet to obtain the first packet, and to forward the first packet to one or more clients associated with the home network.

19. The edge device of claim 18, wherein the first packet is a layer 2 flooded packet.
